(19) United States
(12) Patent Application Publication
(10) Pub. No.: US 2018/0357564 A1
(43) Pub. Date: Dec. 13, 2018

(54) COGNITIVE FLOW PREDICTION

(71) Applicant: INTERNATIONAL BUSINESS MACHINES CORPORATION, Armonk, NY (US)

(72) Inventors: Stefano BRAGHIN, Blanchardstown (IE); Vincent LONIJ, Dublin (IE); Rahul NAIR, Dublin (IE); Rana E. NOVACK, Clifton, VA (US); Paulito PALMES, Dublin (IE)

(73) Assignee: INTERNATIONAL BUSINESS MACHINES CORPORATION, Armonk, NY (US)

(21) Appl. No.: 15/621,067

(22) Filed: Jun. 13, 2017

(51) Int. Cl. G06N 99/00; G06N 5/04

(52) U.S. Cl. CPC G06N 99/005; G06N 5/04

(57) ABSTRACT

Embodiments for intelligent flow prediction by a processor. One or more flows of a domain of interest between target entities may be forecasted according to one or more forecast models learned via machine learning using extracted features of one or more target variables from one or more data sources. The one or more flows may include a quantitative value, an intensity score, an intensity category, or a combination thereof between the target entities.

### BACKGROUND OF THE INVENTION

### Field of the Invention

The present invention relates in general to computing systems, and more particularly to, various embodiments for cognitive flow prediction using a computing processor.

### Description of the Related Art

In today's interconnected and complex society, computers and computer-driven equipment are more commonplace. Processing devices, with the advent and further miniaturization of integrated circuits, have made it possible to be integrated into a wide variety of personal, business, health, home, education, scientific, and other devices. Accordingly, the use of computers, network appliances, and similar data processing devices continue to proliferate throughout society, particularly in the scientific and geological environment.

### SUMMARY OF THE INVENTION

Various embodiments for intelligent flow prediction by a processor, are provided. In one embodiment, by way of example only, a method for intelligent flow prediction, again by a processor, is provided. One or more flows of a domain of interest between target entities may be forecasted according to one or more forecast models learned via machine learning using extracted features of one or more target variables from one or more data sources. The one or more flows may include a quantitative value, an intensity score, an intensity category, or a combination thereof between the target entities.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary cloud computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a diagram depicting an exemplary functional relationship between various aspects of the present invention;

FIG. 5 is an additional block diagram depicting an exemplary functional relationship between various aspects of the present invention;

FIG. 6 is a chart diagram depicting an exemplary flow prediction model processing text data by a processor in which aspects of the present invention may be realized;

FIG. 7 is a chart diagram depicting an exemplary confusion matrix employing intelligent flow prediction by a processor in which aspects of the present invention may be realized; and

FIG. 8 is a flowchart diagram depicting an exemplary method for intelligent flow prediction by a processor in which aspects of the present invention may be realized.

### DETAILED DESCRIPTION OF THE DRAWINGS

As computing systems continue to increase in technological advancement, the demand for sophisticated prediction, forecasting, and modeling of various conditions and domains of interest also continues to grow. Many entities such as, for example, a country or region may experience increases in population migration to or from a country. For example, a selected region or country may experience an increase in migration as a result of one or more variables. Over time, many data sources such as, for example, newspapers, journals, scientific or governmental studies may document the various reasons or opine on the immigration subject. However, currently there is no solution that provides for automatically mining one or more data sources for flow-based information (e.g., migration flow) of a domain of interest and forecasting the flow of the domain of interest using machine learning of models. Thus, a need exists for predicting and forecasting flows of a selected domain of interest.

Accordingly, various embodiments provide for intelligent flow prediction by one or more processors. One or more flows of a domain of interest between target entities may be cognitively forecasted according to one or more forecast models learned via machine learning using extracted features of one or more target variables from one or more data sources. The one or more flows may include a quantitative value, an intensity score, an intensity category, or a combination thereof between the target entities.

In one aspect, the present technology provides a cognitive and physical modeling platform to predict one or more flows of a domain of interest between selected or defined regions (e.g., between Country A and Country B). In one aspect, a text corpus describing a target variable may be ingested using, for example, natural language processing (NLP). For example, target variables may represent bilateral trade flows between two countries, or number of migrants moving between two areas. That is, an NLP pipeline that maps text data to a set of target variables, including an entity extraction and feature extraction component. One or more relevant features and/or characteristics relating to the target variable may be extracted from the ingested text corpus. A machine learning model may be employed to map features and/or characteristics to the target variable. A training operation may be performed to train and score a learned machine learning model relating to a forecast flow model. The present invention may forecast flows between one or more entities based on the extracted features from the mined text corpus. The flows may be quantitative values, intensity scores, or intensity categories between pairs or tuples of entities.

In one aspect, the present invention provides for an automated system to forecast and/or estimate flows (relating to a selected topic, domain of interest, or target variables) between entities from one or more data sources (e.g., text data sources). For example, the present invention may estimate a flow of interest such as, for example, a population flow, trade flows (goods or services), or other measurable variables between two selected regions/countries based on a corpus of text data from trade-related publication. As an additional example, the present invention may estimate a migration flow (e.g., immigration flow of persons from one country to another) between selected regions based on a corpus of text data (e.g., newspapers, articles, journals, reports, blogs, websites, economic publications, government publications, etc.). A machine learning pipeline, one that encodes and describes a sequence of steps a computing device performs to generate flow predictions, may be leveraged that may include a natural language processing (NLP) component and a machine learning model to make the forecasts of a selected flow of interest.

In one aspect, a domain of interest may include a thesaurus, an ontology or domain knowledge may be used for intelligent flow prediction. The thesaurus and ontology may also be used to identify one or more similar characteristics between one or more target variables and/or regions related concepts representing a domain knowledge of the one or more heterogeneous data sources, and/or data flows.

In one aspect, the term “domain” is a term intended to have its ordinary meaning. In addition, the term “domain” can include an area of interest and/or expertise for a topic, system or a collection of material, information, content and/or other resources related to a particular subject or subjects. For example, a domain can refer to energy, financial, socio-economic, political, transportation, scientific, industrial, and/or climate information. A domain can refer to information related to any particular topic, subject matter or a combination of selected subjects. The domain may also include one or more characteristics that may include one or more target variables, regions, geography, temperature, population, migration, trade (e.g., goods or services), weather data, defined area of interest/topic, or a combination thereof.

The term ontology is also a term intended to have its ordinary meaning. In one aspect, the term ontology in its broadest sense may include anything that can be modeled as ontology, including but not limited to, taxonomies, thesauri, vocabularies, and the like. For example, an ontology may include information or content relevant to a domain of interest or content of a particular class or concept. Content can be any searchable information, for example, information distributed over a computer-accessible network, such as the Internet. A concept can generally be classified into any of a number of concepts which may also include one or more sub-concepts. Examples of concepts or domains of interest may include, but are not limited to, scientific information, economic information, sociological information, medical information, governmental information, financial information, weather data, climate data, geographical information, immigration information, trade (e.g., trade of goods and/or services between various regions), information or content relevant to a domain of interest or content of a particular class or concept, websites and databases, or a combination thereof. The ontology can be continuously updated with the information synchronized with the sources, adding information from the sources to the ontology as models, attributes of models, or associations between models within the ontology.

The domain knowledge may be searched and queried to identify similar characteristics between the selected domains of interest and one or more alternative domains of interest. The domain knowledge may also include information, historical data, observational data, and/or feedback data learned using a machine learning operation based on extracted data from ingested information from one or more data sources. The domain knowledge may also include and/or be in communication with websites and databases for identifying one or more data sources, which may be continuously updated, monitored, and/or maintained.

In an additional aspect, cognitive or “cognition” may refer to a mental action or process of acquiring knowledge and understanding through thought, experience, and one or more senses using machine learning (which may include using sensor based devices or other computing systems that include audio or video devices). Cognitive may also refer to identifying patterns of behavior, leading to a “learning” of one or more events, operations, or processes. Thus, the cognitive model may, over time, develop semantic labels to apply to observed behavior and use a knowledge domain or ontology to store the learned observed behavior. In one embodiment, the system provides for progressive levels of complexity in what may be learned from the one or more events, operations, or processes.

In an additional aspect, the term cognitive may refer to a cognitive system. The cognitive system may be a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with a high degree of accuracy (e.g., within a defined percentage range or above an accuracy threshold) and resilience on a large scale. A cognitive system may perform one or more computer-implemented cognitive operations that approximate a human thought process while enabling a user or a computing system to interact in a more natural manner. A cognitive system may comprise artificial intelligence logic, such as natural language processing (NLP) based logic, for example, and machine learning logic, which may be provided as specialized hardware, software executed on hardware, or any combination of specialized hardware and software executed on hardware. The logic of the cognitive system may implement the cognitive operation(s), examples of which include, but are not limited to, question answering, identification of related concepts within different portions of content in a corpus, and intelligent search algorithms, such as Internet web page searches.

In general, such cognitive systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) High degree of relevant recollection from data points (images, text, voice) (memorization and recall); and/or 13) Predict and sense with situational awareness operations that mimic human cognition based on experiences.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

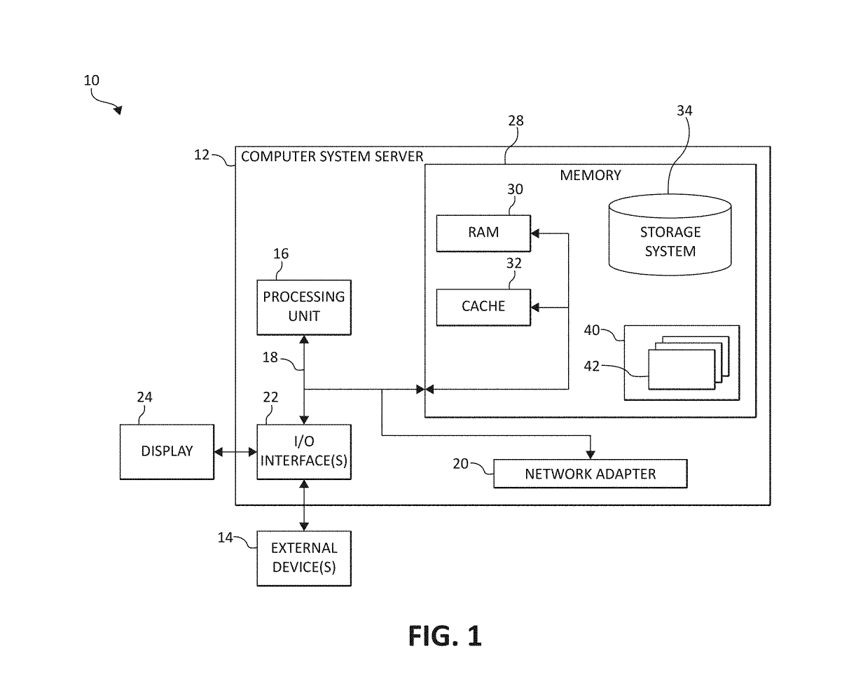

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

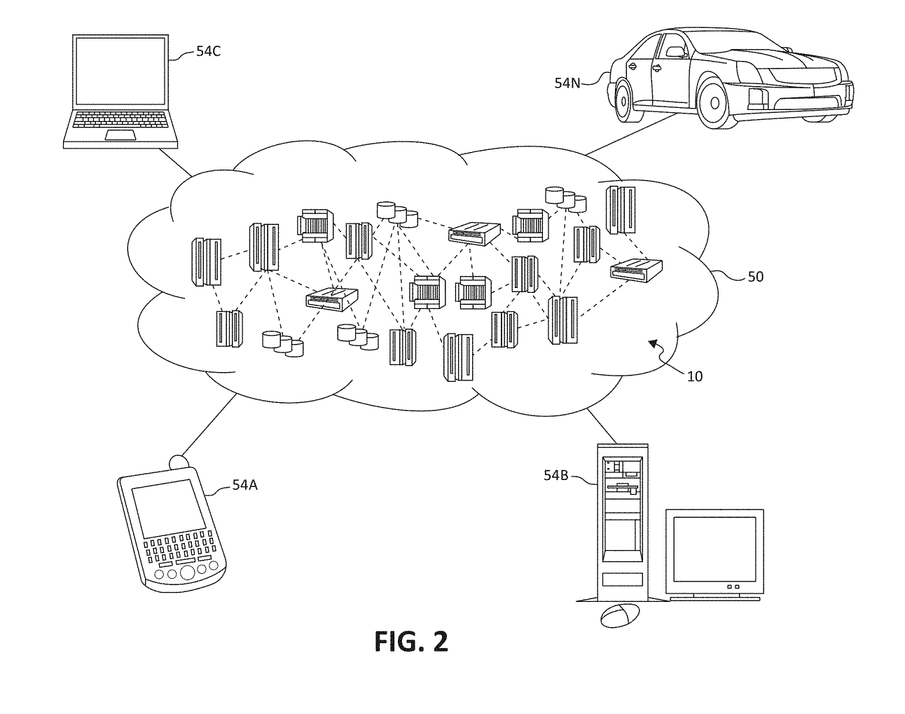

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

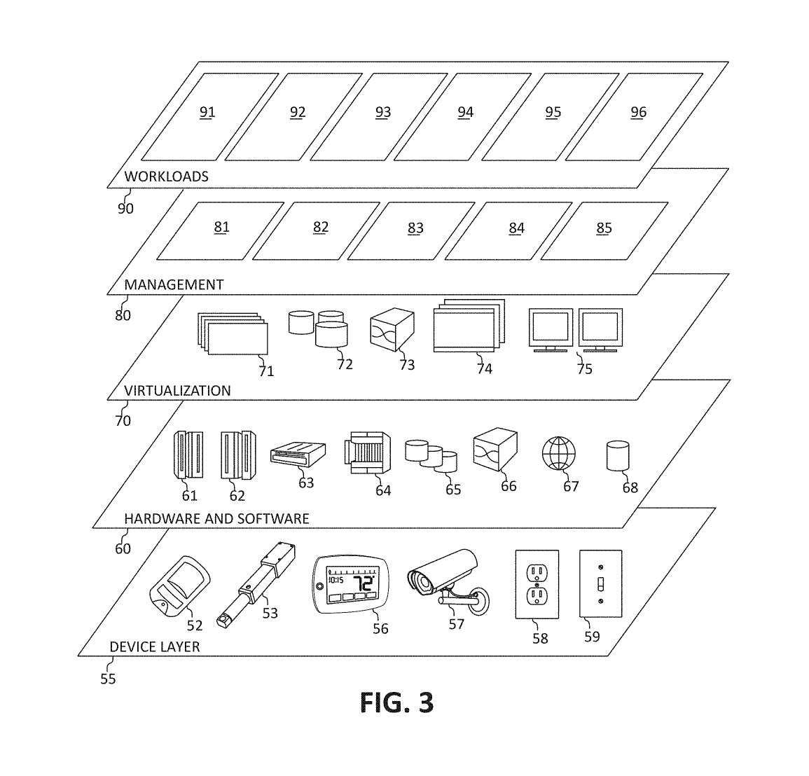

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various flow-based information estimation/forecasting workloads and functions 96. In addition, flow-based information estimation/forecasting workloads and functions 96 may include such operations automated data exploration and validation, and as will be further described, user and device management functions. One of ordinary skill in the art will appreciate that the flow-based information estimation/forecasting workloads and functions 96 may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

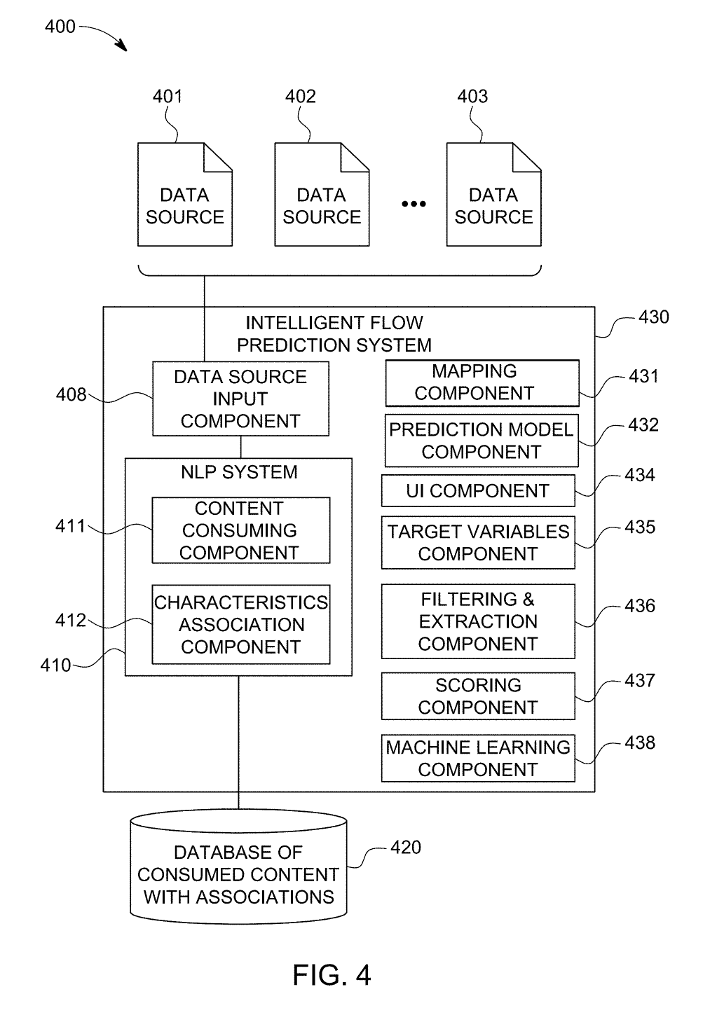

Turning now to FIG. 4, a block diagram of exemplary functionality 400 relating to cognitive flow prediction is depicted. As shown, the various blocks of functionality are depicted with arrows designating the blocks' 400 relationships with each other and to show process flow. Additionally, descriptive information is also seen relating each of the functional blocks 400. As will be seen, many of the functional blocks may also be considered “modules” of functionality, in the same descriptive sense as has been previously described in FIGS. 1-3. With the foregoing in mind, the module blocks 400 may also be incorporated into various hardware and software components of a system for cognitive flow prediction in accordance with the present invention, such as those described in FIGS. 1-3. Many of the functional blocks 400 may execute as background processes on various components, either in distributed computing components, or on the user device, or elsewhere.

Multiple data sources 401-403 may be provided as a corpus or group of data sources defined by a user. The data sources 401-403 may include, but are not limited to, data sources relating to one or more topics, subjects, domains of interests, or regions (e.g., a community, region, defined geographical area, country, and the like) such as, for example, newspaper articles discussing recent trends about immigration for a selected country. Another example may be a governmental report discussing features or characteristics about a trade agreement for goods/services between various countries. The data sources 401-403 may be all of the same type, for example, newspapers, journals, scientific papers, academic reports, conference materials, pages or articles in a wiki or pages of a blog. Alternatively, the data sources 401-403 may be of different types, such as word documents, wikis, web pages, power points, printable document format, or any document capable of being analyzed by a natural language processing system.

In addition to text based documents, other data sources such as audio, video or image sources may also be used wherein the documents may be pre-analyzed to extract their content for natural language processing, such as converting from audio to text and/or image analysis.

The group of data sources 401-403 are consumed for an intelligent flow prediction system 430 using natural language processing (NLP) and artificial intelligence (AI) to provide processed content.

In one example, an instance of IBM® Watson® (IBM and Watson are trademarks of International Business Machines Corporation) NLP is used. The instance of Watson is provided and pointed at the group of data sources. The aspects of Watson that the described method and system makes use of are the technologies behind Alchemy Language (Alchemy Language is a trademark of International Business Machines Corporation). However, other NLP technologies or services may be used to provide the processed content as described herein.

The data sources 401-403 may be analyzed by an NLP system 410 to data mine the relevant information from the content of the data sources 401-403 in order to display the information in a more usable manner and/or provide the information in a more searchable manner. The NLP system 410 may be an instance of an NLP and AI tool such as Watson, which may be provided as a cloud service or as a local service.

The NLP system 410 may consume the multiple data sources 401-403 as selected by using a data source input component 408, including, for example, word docs, newspapers, online journals, reports, wikis, web pages, power points, Internet word docs, knowledge centers, anything that the NLP system 410 knows how to understand. This may extend to non-text based documents, by providing pre-analyzing of the content such as audio to text processing.

The NLP system 410 may include a content consuming component 411 for inputting the data sources 401-403 and running its NLP and AI tools against them, learning the content, such as by using the machine learning component 438. The content consuming component 411 may also mine the content consumed. As the NLP system 410 (including the machine learning component 438) learns different sets of data, a characteristics association component 412 (or “cognitive characteristics association component”) may use the artificial intelligence to make cognitive associations or links between data sources 401-403 by determining common concepts, similar characteristics, and/or an underlying common topic.

Cognition is the mental process of knowing, including aspects such as awareness, perception, reasoning and judgment. An AI system uses artificial reasoning to interpret the data sources 401-403 and extract their topics or concepts. The learned topics and concepts may not be specifically named or mentioned in the data sources 401-403 and is derived by the AI interpretation.

The learned content of the data sources consumed by the NLP system may be merged into a database 420 or other data storage method of the consumed content with learned concepts of the data sources 401-403 providing association between the content referenced to the original data sources 401-403. The digital content of the original data sources 401-403 remains in the original data sources such as the wiki, web pages, etc., but the database 420 will have a logical understanding of how the original data sources 401-403 fit together using the power of the AI allowing for the concepts and therefore the associations or mappings between the data sources.

The merging of the data into one database 420 allows the intelligent flow prediction system 430 to act like a search engine, but instead of key word searches, it will use an AI method of making cognitive associations between the data sources using the deduced concepts.

The intelligent flow prediction system 430 may include a user interface component 434 (e.g., an interactive graphical user interface “GUI”) providing user interaction with the indexed content for mining and navigation and/or receiving one or more inputs/queries from a user.

The intelligent flow prediction system 430 may include a mapping component 431 for mapping (and indexing) the content and characteristics of the content. The mapping component 431 may provide a map index of topics or concepts of the consumed data sources 401-403 as consumed by the NLP system mapping to the data sources 401-403. The map index may list sub-topics and hierarchies for navigation and includes links or references to the original data sources 401-403.

The intelligent flow prediction system 430 may also include a prediction model component 432 for predicting and forecasting flow-based information relating to a selected topic or domain of interest (e.g., migration flow of people between country A and country B or estimated trade flow of goods and/or services between country A and country B). Once the NLP system 410 has carried out the linking of the data, the prediction model component 432 may mine the associated concepts or similar characteristics from the database 420 of the consumed content to provide the most relevant sets of data sources for a topic being searched and use the associated concepts or similar characteristics to predict and forecast flow-based information relating to a selected topic or domain of interest between one or more selected entities.

The intelligent flow prediction system 430 may also include a target variables component 435 (or target flow variables component) for defining one or more target flow variables of interest. Such target flow variables, for example, may include trade flows between two countries, a number of migrants from one area/region to another area/region, and/or contract relationships between different business entities. Thus, one or more data sources 401-403 (e.g., text corpus) may be filtered based on topics relating to the target flow variables.

The intelligent flow prediction system 430 may also include filtering and extraction component 436 for extracting the extracted features from the one or more data sources. That is, the filtering and extraction component 436 may work in conjunction with the NLP system 410 to consume and mine one or more data sources 401-403 for a topic or subject, including associated features and/or characteristics of the topic or subject.

The intelligent flow prediction system 430 may also include a scoring component 437 for scoring each of the one or more forecast models, wherein a forecast model having a highest score in comparison to other forecast models having lower scores is used for the forecasting. The scoring component 437 may work in conjunction with the prediction model component 432 for predicting and forecasting flow-based information relating to a selected topic or domain of interest and scoring and/or ranking each of the forecast models used for the predicting or forecasting.

In one aspect, a calculation or computation operation of the scoring component 437 may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

The scoring component 437 and/or the machine learning component 438 may apply one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

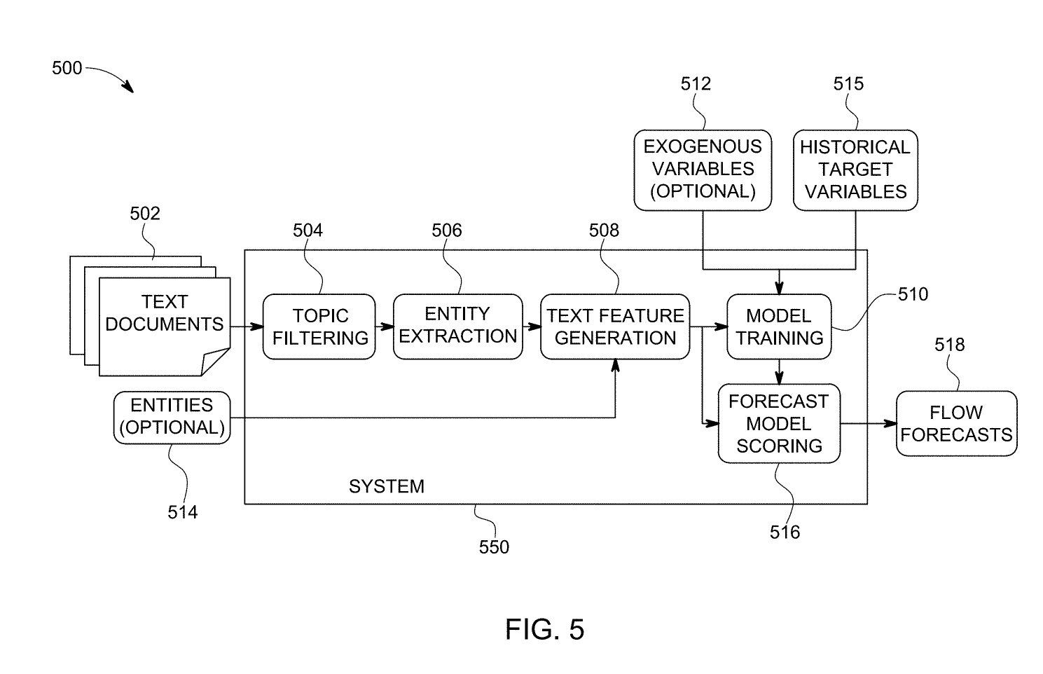

Turning now to FIG. 5, a block diagram of exemplary functionality 500 relating to intelligent flow prediction is depicted, for use in the overall context of cognitive flow prediction according to various aspects of the present invention. As shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality, in the same descriptive sense as has been previously described in FIG. 4. With the foregoing in mind, the module blocks 500 may also be incorporated into various hardware and software components of a system for image enhancement in accordance with the present invention. Many of the functional blocks 500 may execute as background processes on various components, either in distributed computing components, or on the user device, or elsewhere, and generally unaware to the user performing generalized tasks.

Starting with block 502, one or more data sources (e.g., text documents) may be ingested into system 550, such as computer system/server 12 of FIG. 1. At block 504, a topic filtering operation may be performed where a text corpus (e.g., the data sources) may be filtered based on topics relating to one or more target flow variables relating to an area of interest. At block 506, an entity extraction operation may be performed by automatically extracting one or more entities (e.g., one or more regions, countries, business entities, organization entities, names or persons, or a combination thereof from the text corpus). A feature generation operation may be performed where one or more features (or characteristics) and relationships between one or more entities 514 may be automatically extracted, as in block 508. At block 510, a model training operation may be performed to train a machine learning model from the text, and optionally exogenous features 512 and historical target variables 515. A model scoring operation may be performed to score a trained model (e.g., a scored forecast model) to generate a flow forecast, as in block 516. A flow forecast may be performed, as in block 518. That is, block 518 may forecast one or more flows of a domain of interest between target entities according to one or more forecast models learned via machine learning using extracted features of one or more target variables from one or more data sources, wherein the one or more flows include a quantitative value, an intensity score, an intensity category, or a combination thereof between the target entities.

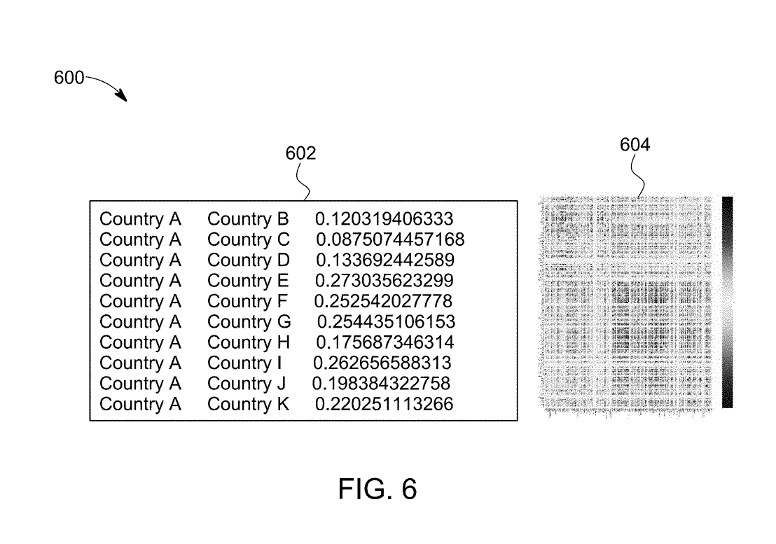

FIG. 6 is a chart diagram 600 depicting an exemplary flow prediction model processing text data by a processor. As illustrated in FIG. 6, a flow such as, for example, an immigration/population flow, between one or more target entities (e.g., country A and country B), may be forecasted according to one or more forecast models learned via machine learning using extracted features of one or more target variables from one or more data sources (which may be data sources selected during a defined period of time). For example, one or more news articles may be mined (that have been collected for a selected period of time such as for 10 years) for selected terms/text discussing a topic of interest (e.g., the immigration between country A and one or more alternative countries such as countries B-K). Text words relating to the target variables of a domain of interest may be collected and grouped together. A trained, prediction model may be used to predict the flow. A similarity score between the countries may be used to reflect a degree of importance of flow patterns (e.g., immigration flow patterns) as illustrated in block 602. The flows include a quantitative value, an intensity score, an intensity category, or a combination thereof between the target entities, as depicted in block 604. For example, a similarity score is depicted as output of similarities in block 602 showing numerical values of the similarity scores while block 604 depicts an intensity score between country A and each of the alternative countries B-K. It should be noted that the intensity scores of block 604 may be defined according to user preference such as, for example, more similar scores may be a “darker” shade while those having less similarity scores may be a “lighter” shade. The similarity scores may be used with a machine learning pipeline to forecast target variables.

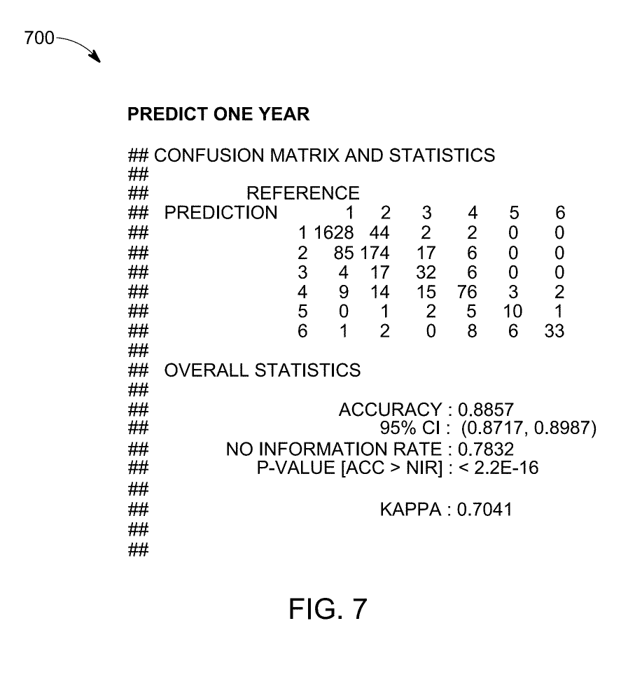

Turning now to FIG. 7, a chart diagram showing how the prediction model performs through an exemplary confusion matrix 700 employing intelligent flow prediction by a processor is depicted. In one aspect, the confusion matrix 700 may be a means, method, procession, and/or operation to visualize an error of a statistical model. For example, FIG. 7 depicts an example where a prediction model was tasked with forecasting a flow intensity in six categories (numbered 1 through 6). Each column represents “truth” or actual values and each row denotes the category predicted by the model. The number within the confusion matrix 700 such as, for example, a number at row 1 and column 2, may denote a number of cases (e.g., the number 44) when the prediction model predicted a category 1 when in fact the correct (true) value was category 2. In a perfect model, all predictions should equal the ground truth (e.g., all values should be along the diagonal of the matrix). In FIG. 7, the example using the confusion matrix 700 illustrates large numbers along the diagonal of the columns and rows and smaller numbers in cells that are off the diagonal. This indicates the prediction model is performing as intended. For example, the overall accuracy of the model is 88.57%. Additionally, 95% confidence intervals are also shown. The probability values (p-value) and kappa metrics show the statistical summary of the model.

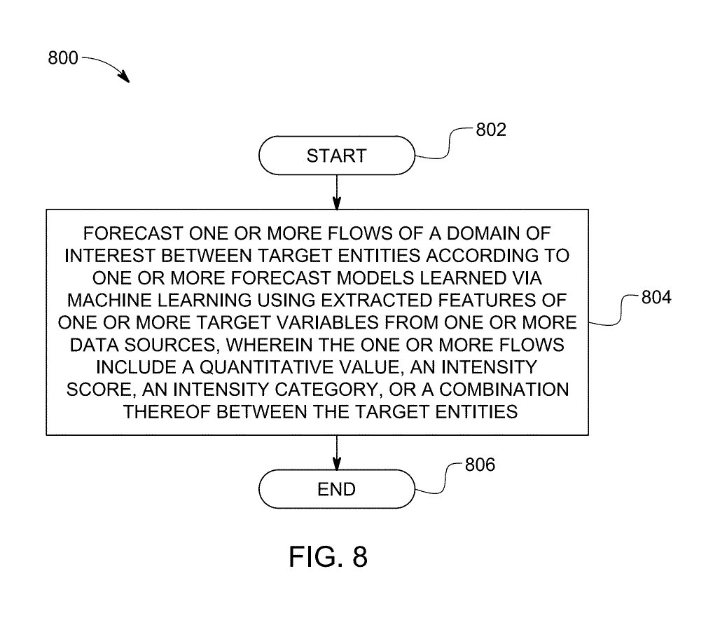

Turning now to FIG. 8, an additional method 800 for intelligent flow prediction by a processor is depicted, in which various aspects of the illustrated embodiments may be implemented. The functionality 800 may be implemented as a method executed as instructions on a machine, where the instructions are included on at least one computer readable medium or one non-transitory machine-readable storage medium. The functionality 800 may start, as in block 802. One or more flows of a domain of interest between target entities may be forecasted according to one or more forecast models learned via machine learning using extracted features of one or more target variables from one or more data sources, as in block 804. The one or more flows may include a quantitative value, an intensity score, an intensity category, or a combination thereof between the target entities. The functionality 800 may end in block 806.

In one aspect, in conjunction with and/or as part of at least one block of FIG. 8, the operations of method 800 may include each of the following. The operations of method 800 may mine one or more data sources that describe one or more selected topics related to the one or more target variables. Various features and/or characteristics may be extracted from the mined data sources that are related to the one or more target variables. A machine learning mechanism may be implemented for providing the one or more forecast models relating to the extracted features, historical data, historical target flow variables, or a combination thereof relating to the one or more target variables. Each one of the forecast models may be scored such that a forecast model having a highest score in comparison to other forecast models having lower scores is used for the forecasting.

The operations of method 800 may receive one or more inputs associated with the one or more data sources. The forecasting further includes matching quantitative and qualitative characteristics relating to the one or more target variables using text analysis on the content of one or more data sources and forecasting the one or more flows using the matching quantitative and qualitative characteristics.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for intelligent flow prediction, comprising:
forecasting one or more flows of a domain of interest between target entities according to one or more forecast models learned via machine learning using extracted features of one or more target variables from one or more data sources, wherein the one or more flows include a quantitative value, an intensity score, an intensity category, or a combination thereof between the target entities.

2. The method of claim 1, further including mining the one or more data sources that describe one or more selected topics related to the one or more target variables.

3. The method of claim 1, further including extracting the extracted features from the one or more data sources.

4. The method of claim 1, further including implementing a machine learning mechanism for providing the one or more forecast models relating to the extracted features, historical data, historical target flow variables, or a combination thereof relating to the one or more target variables.

5. The method of claim 1, further including scoring each of the one or more forecast models, wherein a forecast model having a highest score in comparison to other forecast models having lower scores is used for the forecasting.

6. The method of claim 1, further including receiving one or more inputs associated with the one or more data sources.

7. The method of claim 1, wherein the forecasting further includes:
matching quantitative and qualitative characteristics relating to the one or more target variables using text analysis on the content of one or more data sources; and
forecasting the one or more flows using the matching quantitative and qualitative characteristics.

8. A system for intelligent flow prediction, comprising:
one or more computers with executable instructions that when executed cause the system to:
forecast one or more flows of a domain of interest between target entities according to one or more forecast models learned via machine learning using extracted features of one or more target variables from one or more data sources, wherein the one or more flows include a quantitative value, an intensity score, an intensity category, or a combination thereof between the target entities.

9. The system of claim 8, wherein the executable instructions mine the one or more data sources that describe one or more selected topics related to the one or more target variables.

10. The system of claim 8, wherein the executable instructions extract the extracted features from the one or more data sources.

11. The system of claim 8, wherein the executable instructions implement a machine learning mechanism for providing the one or more forecast models relating to the extracted features, historical data, historical target flow variables, or a combination thereof relating to the one or more target variables.

12. The system of claim 8, wherein the executable instructions score each of the one or more forecast models, wherein a forecast model having a highest score in comparison to other forecast models having lower scores is used for the forecasting.

13. The system of claim 8, wherein the executable instructions receive one or more inputs associated with the one or more data sources.

14. The system of claim 8, wherein the executable instructions:
match quantitative and qualitative characteristics relating to the one or more target variables using text analysis on the content of one or more data sources; and
forecast the one or more flows using the matching quantitative and qualitative characteristics.

15. A computer program product for, by a processor, intelligent flow prediction, the computer program product comprising a non-transitory computer-readable storage medium having computer-readable program code portions stored therein, the computer-readable program code portions comprising:
an executable portion that forecasts one or more flows of a domain of interest between target entities according to one or more forecast models learned via machine learning using extracted features of one or more target variables from one or more data sources, wherein the one or more flows include a quantitative value, an intensity score, an intensity category, or a combination thereof between the target entities.

16. The computer program product of claim 15, further including an executable portion that:
mines the one or more data sources that describe one or more selected topics related to the one or more target variables; and
extracts the extracted features from the one or more data sources.

17. The computer program product of claim 15, further including an executable portion that implements a machine learning mechanism for providing the one or more forecast models relating to the extracted features, historical data, historical target flow variables, or a combination thereof relating to the one or more target variables.

18. The computer program product of claim 15, further including an executable portion that scores each of the one or more forecast models, wherein a forecast model having a highest score in comparison to other forecast models having lower scores is used for the forecasting.

19. The computer program product of claim 15, further including an executable portion that receives one or more inputs associated with the one or more data sources.

20. The computer program product of claim 15, further including an executable portion that:
matches quantitative and qualitative characteristics relating to the one or more target variables using text analysis on the content of one or more data sources; and
forecasts the one or more flows using the matching quantitative and qualitative characteristics.
